(19) United States
(12) Patent Application Publication
(10) Pub. No.: US 2005/0255194 A1
(43) Pub. Date: Nov. 17, 2005

(54) Method of scheduling a production run of bakery products

(76) Inventor: Paul Eaton Willett, Queensland (AU)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/509,809

(22) PCT Filed: Apr. 2, 2003
(86) PCT No.: PCT/AU03/00313

§ 371 Date: May 19, 2005

(30) Foreign Application Priority Data
Apr. 2, 2002 (AU) PS 1478
Apr. 22, 2002 (AU) PS 1871

(51) Int. Cl. A23L 1/31

(52) U.S. Cl. 426/56

(57) ABSTRACT

The invention provides a method, computer program and system by which a production schedule for a bakery is produced. The method involves reducing dough wastage by calculating a weight of dough for each bakery product which falls short of a full batch and combining that weight for the various bakery products formed from the same dough type to form batches comprising a whole number of bags of flour. This avoids the partial use of a bag of flour and reduces dough wastage.

### FIELD OF THE INVENTION

This invention relates to a method of scheduling a production run of bakery products. Specifically, this invention relates to a method of scheduling a production run of bread products and therefore will be described in this context. However, it should be appreciated that other bakery products such as biscuits, cakes and/or buns or the like may be produced using the method.

### BACKGROUND OF THE INVENTION

Consumers today demand a large variety of bakery products. For example it is not unusual for a bakery to produce rolls, loaves and/or buns of varying weights and shapes from white dough, wholemeal dough, oat bran dough, soy linseed dough and fruit dough. When a combination of these bakery products are produced it is not unusual for over one hundred bakery products to be produced in a single production run.

Supermarkets often require different production runs compared to small boutique bakeries. For example, supermarkets normally want their shelves full of bread at opening and run only smaller production runs during the day. Boutique bakeries may only bake their products in a single production run or bake their products continuously through the day.

It is usual that demand for bakery products varies throughout a single week. For example, weekend demand is normally higher than weekday demand. More exotic bakery products are also required on weekends.

It requires great skill and expertise to schedule a production run to produce all of the desired bakery products by a specified time. The major difficulty with producing a large variety of bakery products is there is often a large wastage of dough. It is not unusual for bakeries to waste up to 20 percent of dough from each batch. Further, once a production run has been planned it is difficult to change a production run mid stream without creating substantial waste. Still further, it is preferable that full bags of flour are used as partially full opened bags need to be decanted and weighted prior to use.

### OBJECT OF THE INVENTION

It is an object of the invention to overcome or alleviate one or more of the aforementioned disadvantages and/or provide the consumer with a useful or commercial choice.

### SUMMARY OF THE INVENTION

In a first aspect, although not necessarily the only or broadest form, the invention resides in a method for scheduling a production run of bakery products including the steps of:
determining bakery products to be produced including a dough type, a weight of dough of each said bakery product and a number of said bakery products to be produced;
organising each bakery product into a group according to the dough type;
calculating a total weight of dough of each bakery product to be produced;
calculating a number of full batches that can be produced of each bakery product;
calculating a weight of dough for each bakery product that cannot be produced in a batch comprising a whole number of bags of flour; and
combining the respective weights of dough for bakery products of the same dough type that cannot be produced in a batch comprising a whole number of bags of flour into such a batch.

Preferably, the combined batches are full batches.

A production run can be defined as bakery products that are produced in a plurality of batches.

A batch can be defined as a single weight of dough produced at one time for baking.

Preferably, the above method is completed using a computer program and a database.

Preferably, each batch is displayed on a visual display unit. Each batch may be displayed graphically on the visual display unit. The bakery products produced in each batch may be identified graphically.

Preferably, the number of the bakery products can be changed to obtain full batches in the schedule. Preferably amendments may be made to a production run.

Preferably, the sequence of batches in a production run may be varied to suit specific requirements.

Preferably, an ingredient list is provided for each dough type. The ingredient list may be entered and/or changed for each dough type. The weight of ingredients for individual batches may be calculated dependent upon the total weight of the batch.

A schematic layout of how dough pieces are to be arranged on baking trays or in containers, prior to proving or baking, may be displayed graphically.

More preferably, the computer program controls or works in conjunction with a mixing machine.

Logs may be available to monitor historical baking times, batch production and production runs.

The day's production run may be used to calculate the total flour requirement for the day.

In a second aspect, the invention provides a computer program for scheduling a production run of determined bakery products in predetermined quantities, the program being capable of performing the steps of:
organising each bakery product into a group according to the dough type;
calculating a total weight of dough of each bakery product to be produced;
calculating a number of full batches that can be produced of each bakery product;
calculating a weight of dough for each bakery product that cannot be produced in a batch comprising a whole number of bags of flour; and
combining the respective weights of dough for bakery products of the same dough type that cannot be produced in a batch comprising a whole number of bags of flour into such a batch.

A third aspect of the invention provides a computer program for scheduling a production run of determined bakery products in predetermined quantities, the computer program being in a computer readable form and being capable of performing the steps of:
organising each bakery product into a group according to the dough type;
calculating a total weight of dough of each bakery product to be produced;
calculating a number of full batches that can be produced of each bakery product;
calculating a weight of dough for each bakery product that cannot be produced in a batch comprising a whole number of bags of flour; and
combining the respective weights of dough for bakery products of the same dough type that cannot be produced in a batch comprising a whole number of bags of flour into such a batch.

The invention further provides, in a fourth aspect, a baking system including a computer with memory and a computer program according to the third aspect.

### BRIEF DESCRIPTION OF THE DRAWINGS

An embodiment of the invention, by way of example only, will now be described with reference to the accompanying figures in which:

FIG. 1 is a flow chart of the steps performed by a computer program according to the second and third aspects of the invention.

FIG. 2 is a table representing the type of bakery products to be produced.

FIG. 3 is a modified table of FIG. 2.

FIG. 4 is a graph representing a white dough production schedule for the table of FIG. 2.

FIG. 5 is a graph representing a white dough production schedule for the table of FIG. 3.

FIG. 6 is a graph representing a modified white dough production schedule of FIG. 5.

FIG. 7 is a graph representing a wholemeal dough production schedule for the table of FIG. 2.

FIG. 8 is a graph representing a wholemeal dough production schedule for the table of FIG. 3.

### DETAILED DESCRIPTION OF THE PREFERRED EMBODIMENT

In this embodiment of the invention, a computer program and database has been developed to schedule a production run of bakery products. The computer program is run on a computer in conjunction with a mixing machine, such as the Genesis baking machine manufactured by Moffat Pty Ltd of Mulgrave, Victoria, Australia, formerly Bakenomics of Narangba, Queensland, Australia, to form a bakery system. The database is maintained on a memory accessible by the computer.

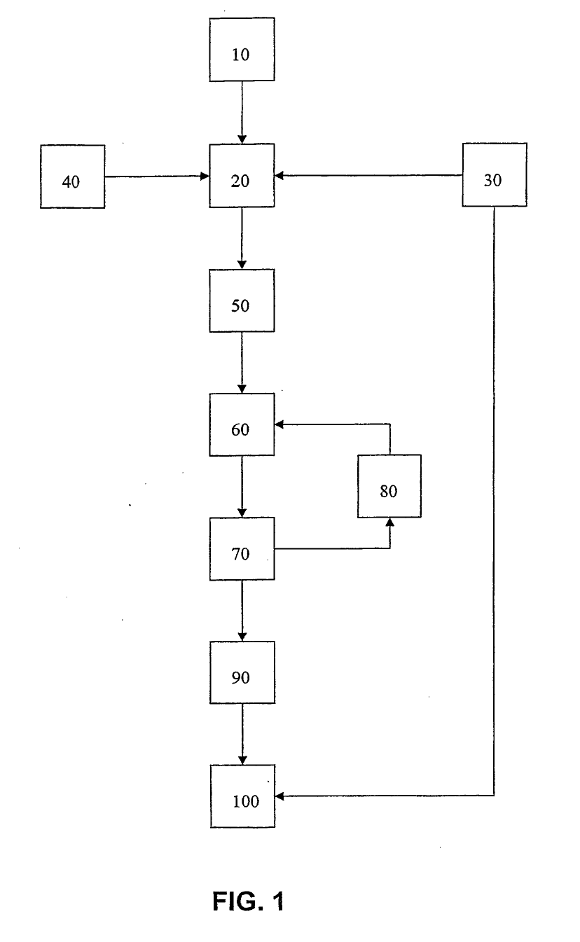

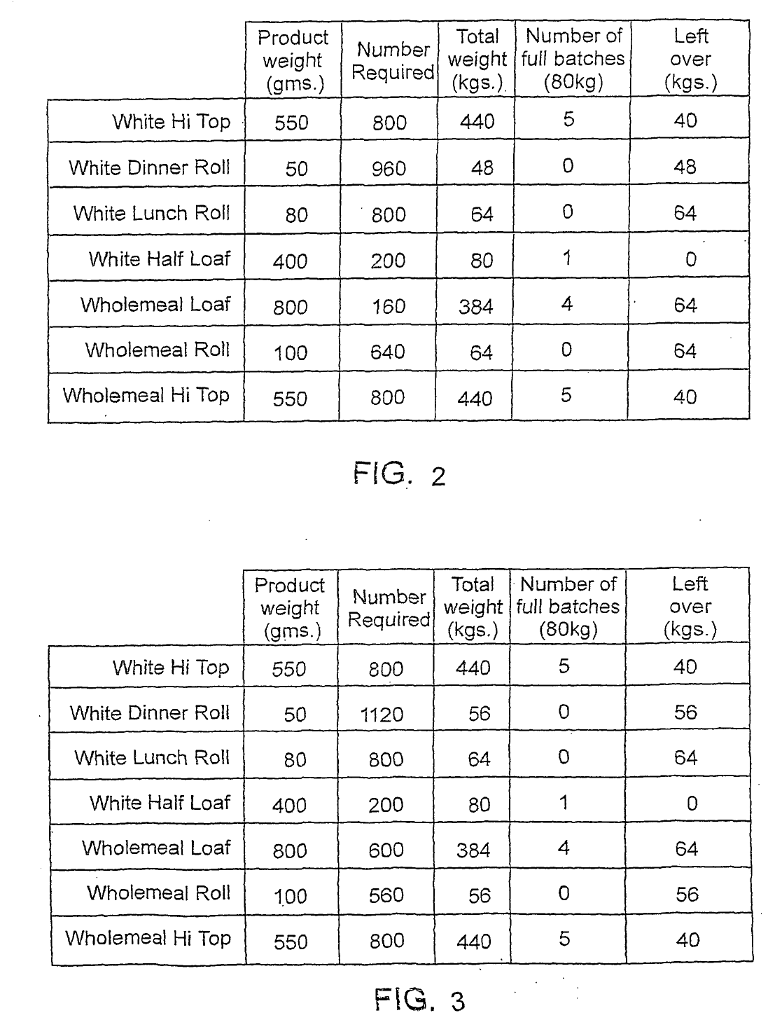

Referring to FIG. 1, to commence operation of the computer program, an operator enters the bakery products 10 that are to be baked into an initial phase. 20 of the computer program. A list of bakery products to be produced is shown in FIG. 2. Normally, the bakery products are associated with individual codes, eg White Hi Top=WHT, but for ease of reference the full name of each of the bakery products has been included in the table. A database 30 contains a full description of each product that is retrieved by the computer program through use of an individual code.

The weight of each of the bakery products is automatically obtained from the database 30. The weight of each bakery product is the weight of the dough that is required to produce the bakery product. The operator then enters the number 40 of each of the bakery products that are desired.

The total weight of dough that is required to produce each of the desired number of each of the bakery products is calculated 50 by the computer program. The total weight is obtained using the following formula:
Product Weight×Number Required=Total Weight

Using the Genesis machine, a batch of 80 kg is produced using a four 12.5 kg bags. A single bag of flour is used to mix 20 kg of dough. It should be appreciated that batch sizes may be increased or decreased depending upon the capabilities of the machine and/or size of the flour bags.

The number of full batches that are needed to produce the number of each of the bakery products is then calculated 60 by the computer program according to the following formula:
Total Weight/Batch Size=No of Full Batches

Depending on number of bakery products that are required, there is often remaining kilograms of bakery product that cannot be produced in a batch comprising a whole number of bags of flour. That is, there is left over bakery product. This remaining weight of bakery product must still be produced to obtain the desired number of product. This method allows the remaining product to be located at a start of a batch. The mixing machine allows a quick change of bakery product so that a batch can have any number of different products.

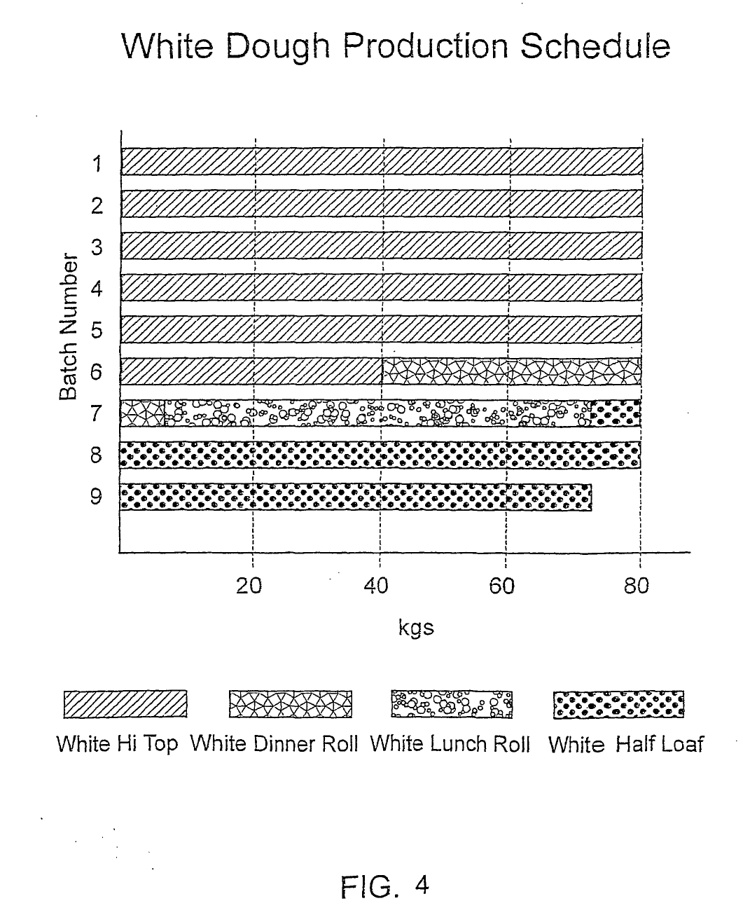

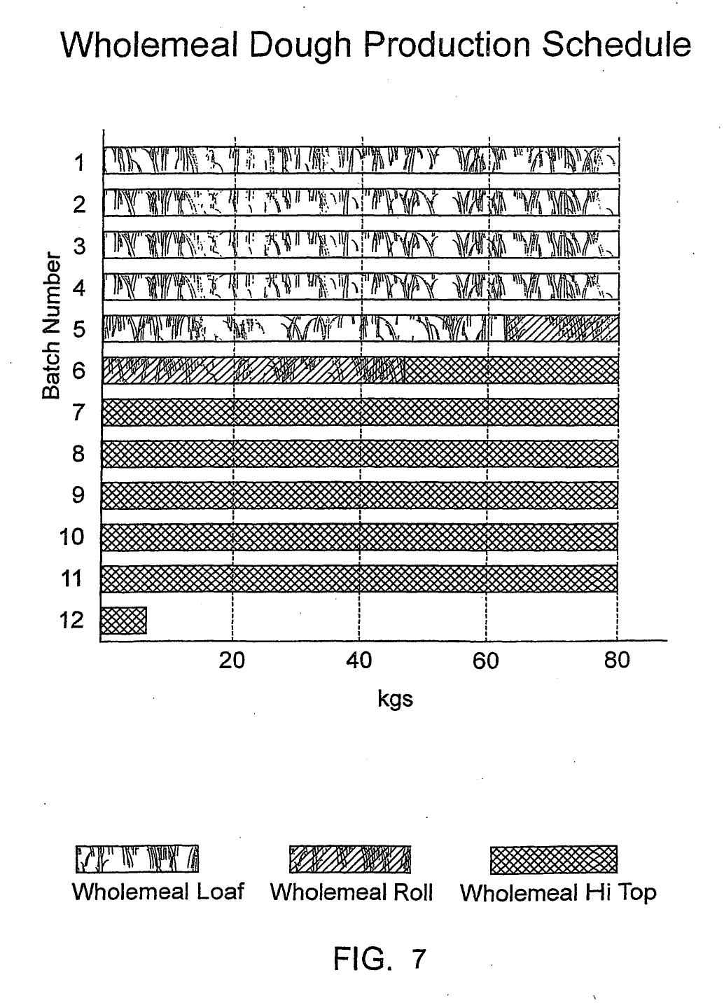

The computer program produces a graphical display 70 on a visual display unit of the production schedule for each dough type as shown in FIG. 4 and FIG. 7. The schedules are produced for each dough type eg. white and wholemeal dough. A shading system is used as a form of graphical identification to differentiate the different bakery products. A key may be produced to represent the different products.

Different production schedules are produced for different dough types. The same batches of dough type are run consecutively as the machine must be cleaned between different dough types being used. Dough types are determined by analysing the codes for each of the bakery products.

The production schedule visually displays if a batch is not a full batch. For example, FIG. 4 shows that there is a short fall of 2 kg in batch 9 and FIG. 7 shows there is a over supply of 2 kg in Batch 12.

An operator can then choose 80 to reduce or increase the number of bakery products to obtain a batch comprising a whole number of bags of flour, but preferably a full batch. For example, after reviewing the production schedules of FIG. 4 and FIG. 7, an operator may increase the number of White Dinner Rolls from 240 to 260 and reduce the number of Wholemeal Rolls from 160 to 140 as shown in FIG. 2.

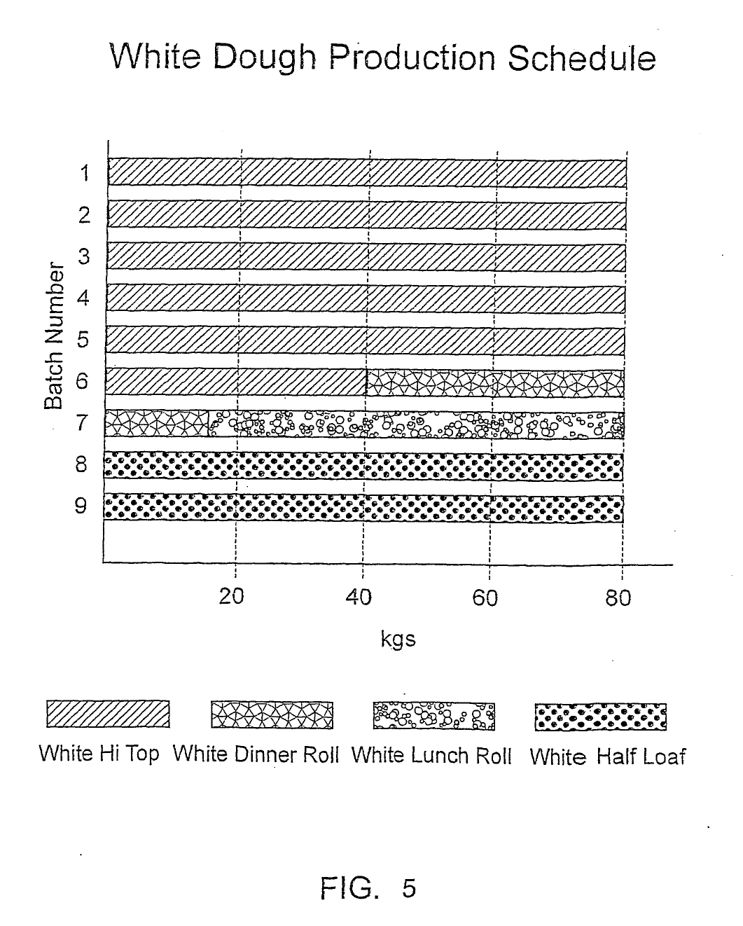

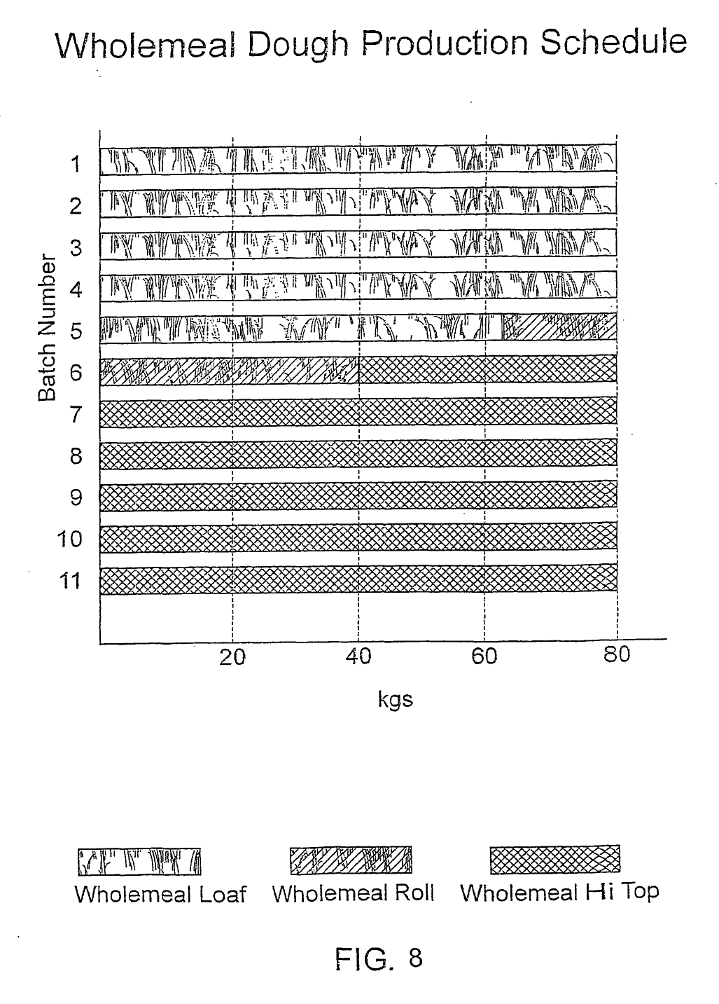

The computer program then recalculates the number of full batches 60 with the modified bakery product numbers and a new production schedule is then produced for visual display 70 as shown in FIG. 5 and FIG. 8. An operator easily sees that the batches are all full from the production schedules.

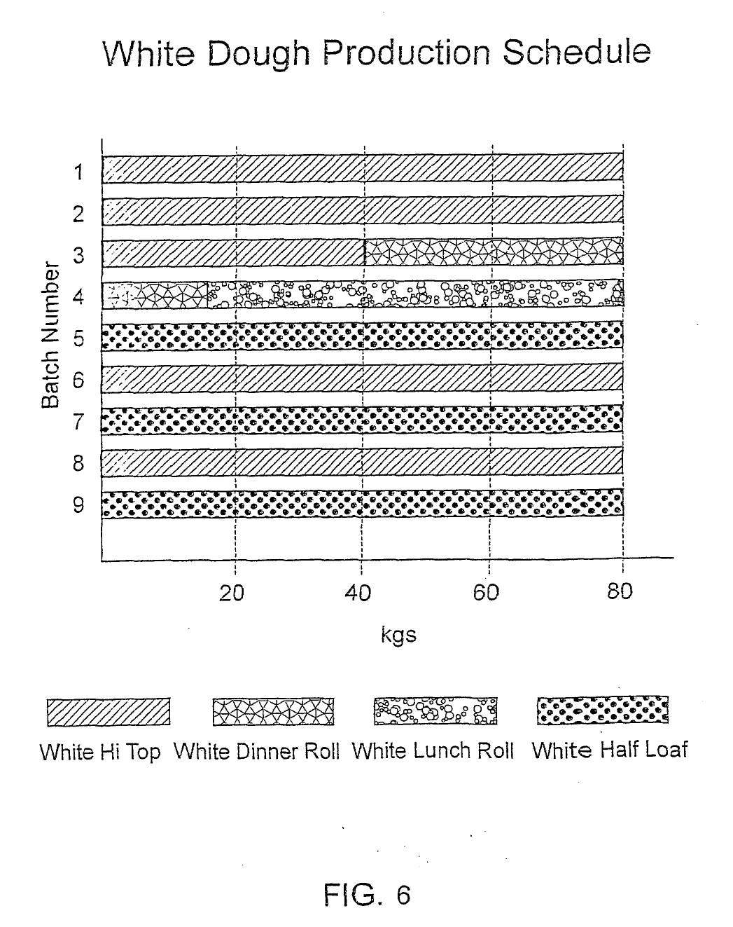

An operator is also able to move batches to different positions on the production schedules to change the order of production as shown in FIG. 6.

One the final production schedule has been determined, then the total days flour requirement for each dough type is calculated 90 by the computer program according to the formula:
Total Weight of Product/Weight of Dough that 1 bag of Flour Produces=Total No. of Flour Bags Required.

The flour can then easily be obtained from a storeroom prior to commencement of the production run.

Typically, the production schedule is produced at least one day before the production run by using the computer program and database. The production run can then be saved and retrieved when desired.

Once the production run is desired, an operator retrieves the production run from a computer. The computer indicates the order of the batches and what products are produced in each batch. An ingredient list is then produced 100 for the first batch. Ingredients typically include the amount of water, the amount of flour, the amount of yeast and any other ingredients.

The list of ingredients and their relative combination ratio needed to produce a specified weight (for example 20 kg) of each dough type are contained in the database 30. They are retrieved from the database 30 when the ingredients list is to be prepared by the computer program. The weight of each of the ingredients is simply a ratio of the amount of dough that is to be produced compared to the standard ratio located in the database.

It should be appreciated that some mixing machines may have automatic dispensing devices that may dispense some ingredients automatically. In this instance, the computer program and database may communicate directly with the mixing machine.

Once each of the ingredients is entered into the mixing machine and the operator confirms this on the computer, the mixing machine is then used to mix the dough. A mixing time for the type of dough is calculated and entered into the mixing machine.

When the dough exits the machine after it has been mixed, the operator is provided with a screen that shows the layout of dough pieces as they are to be arranged on backing trays and/or containers prior to proving and baking. Any instructions relating to the placement of the dough piece and any further ingredients are also indicated.

For example, for white cheese top rolls, a screen may be produced that shows a standard baking tray that has the rolls placed in a 3×4 configuration on the baking tray. The instructions may include turning the dough piece over and place upside-down on baking tray and add cheese to top of roll.

The computer program may also receive feedback from the mixing machine and operator. This feedback is stored in the database for retrieval and analysis. The following may be measured:
1. Machine efficiency=Mixing time vs Loading time of Ingredients
2. Time that each products leaves the mixing machine to provide the individual batch mixing time, the total mixing time, the total lead time and the total time to produce the production run.
3. Any failed production e.g. incorrect ingredients
4. Any amendments made to the production run.

This method allows for little to no wastage of dough. Further, an inexperienced operator can prepare bread products with little or no input from experienced personal as the operator needs to make very few decisions. Feedback can be viewed to assist in producing more efficient operations.

It should be appreciated that various other changes and modifications may be made without departing from the spirit or scope of the invention.

1. A method of producing a production run schedule of bakery products, the method including the steps of:
determining bakery products to be produced including a dough type, a weight of dough of each said bakery product and a number of said bakery products to be produced;
organizing each bakery product into a group according to the dough type;
calculating a total weight of dough of each bakery product to be produced;
calculating a number of full batches that can be produced of each bakery product; calculating a weight of dough for each bakery product that cannot be produced in a batch comprising a whole number of bags of flour; and
combining the respective weights of dough for bakery products of the same dough type that cannot be produced in a batch comprising a whole number of bags of flour into such a batch.

2. A method according to claim 1, wherein the combined batches are full batches.

3. A method according to claim 1, wherein the schedule is amendable to ensure each batch in the schedule includes a whole number of bags of flour.

4. A method according to claim 3, wherein the number of bakery products is amendable to obtain full batches in the schedule.

5. A method according to claim 2, wherein the sequence of batches in the schedule is amendable.

6. A method according to any one of the preceding claims claim 1, wherein the bakery products of the same dough type are arranged in consecutive batches.

7. A method according to claim 1, wherein the number of bakery products is multiplied by a weight of dough required to form a single bakery product, thereby to calculate the total weight of dough for the bakery product.

8. A method according to claim 7, wherein the method further includes displaying the batches, via a computer to permit subsequent amendment.

9. A method according to claim 8, wherein the step of displaying the batches involves displaying the batches graphically.

10. A method according to claim 9, wherein the graphical display of batches includes graphical identification of bakery products forming the displayed batch.

11. A method according to claim 1, wherein the method includes the further step of providing a schematic layout of dough pieces on baking trays or in containers, prior to proving or baking.

12. A computer program for scheduling a production run of determined bakery products in predetermined quantities, the program being capable of performing the steps of:
organizing each bakery product into a group according to the dough type;
calculating a total weight of dough of each bakery product to be produced;
calculating a number of full batches that can be produced of each bakery product;
calculating a weight of dough for each bakery product that cannot be produced in a batch comprising a whole number of bags of flour; and
combining the respective weights of dough for bakery products of the same dough type that cannot be produced in a batch comprising a whole number of bags of flour into such a batch.

13. A computer program according to claim 12, wherein the combined batches are full batches.

14. A computer program according to claim 12, wherein the program performs the further step of displaying the batches to permit subsequent amendments of the schedule.

15. A computer program according to claim 14, wherein the batches are displayed graphically.

16. A computer program according to claim 15, wherein the graphical display of batches includes graphical identification of bakery products forming the displayed batch.

17. A computer program according to claim 16, wherein the program provides a schematic layout of dough pieces on baking trays or in containers, prior to proving or baking.

18. A baking system including:
a computer with memory; and
a computer program according to claim 11.

19. A baking system according to claim 18, wherein the system includes baking machinery linked to the computer for control thereby.

20. A baking system according to claim 19, wherein the baking machinery provide feedback to the program, the feed back comprising any one or more of the following:
a) ingredients mixing and loading times expressed as a machine efficiency;
b) individual batch mixing times;
c) total mixing time;
d) total lead time;
e) total time to produce a production run;
f) failed production; and
g) amendments made to the production run.

21. A computer program for scheduling a production run of determined bakery products in predetermined quantities, the computer program being in a computer readable form and being capable of performing the steps of:
organizing each bakery product into a group according to the dough type;
calculating a total weight of dough of each bakery product to be produced;
calculating a number of full batches that can be produced of each bakery product;
calculating a weight of dough for each bakery product that cannot be produced in a batch comprising a whole number of bags of flour; and
combining the respective weights of dough for bakery products of the same dough type that cannot be produced in a batch comprising a whole number of bags of flour into such a batch.

22. A computer program according to claim 21, wherein the combined batches are full.

23. A computer program according to claim 21, wherein the program performs the further step of displaying the batches to permit subsequent amendments of the schedule.

24. A computer program according to claim 23, wherein the batches are displayed graphically.

25. A computer program according to claim 24, wherein the graphical display of batches includes graphical identification of bakery products forming the displayed batch.

26. A computer program according to claim 25, wherein the program provides a schematic layout of dough pieces on baking trays or in containers, prior to proving or baking.
